(19) United States
(12) Patent Application Publication
(10) Pub. No.: US 2006/0083986 A1
(43) Pub. Date: Apr. 20, 2006

(54) Battery with tin-based negative electrode materials

(76) Inventors: Wen Li, Ann Arbor, MI (US); Keiichi Yokouchi, Shizuoka (JP); Keichi Kohama, Shizuoka (JP)

Correspondence Address: GIFFORD, KRASS, GROH, SPRINKLE & CITKOWSKI, P.C, PO BOX 7021, TROY, MI, 48007-7021, US

(21) Appl. No.: 11/079,988

(22) Filed: Mar. 15, 2005

Related U.S. Application Data
(60) Provisional application No. 60/553,394, filed on Mar. 16, 2004.

(51) Int. Cl. H01M 4/38; H01M 6/24

(52) U.S. Cl. 429/218.1; 429/101

(57) ABSTRACT

An improved battery comprises a negative electrode having a tin-containing material supported by a support material, a positive electrode and an electrolyte (such as a molten salt electrolyte) located between the positive electrode and the negative electrode. The tin-containing material can separated from the electrolyte by a protection layer, which, for example, can slow decomposition of the electrolyte.

### REFERENCE TO RELATED APPLICATION

This application claims priority to U.S. Provisional Patent Application Ser. No. 60/553,394, filed Mar. 16, 2004, the entire content of which is incorporated herein by reference.

### FIELD OF THE INVENTION

The present invention relates to batteries, in particular to lithium-ion batteries.

### BACKGROUND OF THE INVENTION

Safety is a key issue for lithium ion (Li-ion) battery applications because a traditional organic electrolyte often has a high vapor pressure, is flammable, and can explode. Hence, there is a need for improved electrolytes for Li ion batteries.

Molten salt electrolytes have a high melting point and low vapor pressure, and avoid some of the safety problems of conventional organic electrolytes. However, because the oxidation potential of most molten salts is around 1.0 V to 5.0V, application of negative electrode materials with high capacity and low voltage is hindered.

During discharge of a rechargeable battery, the negative electrode is the anode, and the positive electrode is the cathode. It is conventional to refer to the negative terminal of a battery as the anode, and the positive terminal as the cathode. However, the negative terminal is actually the cathode during charging of the battery.

U.S. Pat. No. 6,524,744 to Clerc et al. discloses multi-phase material and electrodes made therefrom, but not the use of tin particles on a catalytic support.

U.S. Pat. No. 6,548,187 to Nagai et al. discloses a Sn based alloy containing Sn—Ti compound, and precursor of Nb₃Sn superconducting wire, but not improved lithium-ion battery electrodes.

Patents mentioned in this specification are incorporated herein by reference.

### SUMMARY OF THE INVENTION

An improved battery comprises a negative electrode having a tin-containing material supported by a support material, a positive electrode, and an electrolyte (such as a molten salt electrolyte) located between the positive electrode and the negative electrode. The battery may be a lithium-ion battery, or other battery type. The tin-containing material can be a tin alloy, tin compound, or other tin-containing material. The tin-containing material can be separated from electrolyte by a protection layer, which can be an oxidized form of the tin-containing material, a polymer, alloy, other metal layer, solid electrolyte layer, or other materials which act to slow decomposition of the electrolyte, or otherwise contributes to the performance or stability of the battery. The protection layer can be formed by decomposition of the electrolyte on the surface of the tin-containing material, for example a component of a molten salt electrolyte. The tin-containing material can be in the form of particles, such as nanoparticles (having an average diameter between approximately 0.5 nm and 1 micron) or microparticles (having an average diameter between approximately 1 micron and 1 mm), the particles being supported by the support material. The negative electrode may further comprise an electron conductive material and a binder.

### BRIEF DESCRIPTION OF THE FIGURES

FIG. 1A shows a structure of a Li-ion battery, having a negative electrode comprising a tin-based material and a molten salt electrolyte;

FIG. 1B shows a detail of a possible negative electrode structure; and

FIG. 2 shows results obtained using a battery such as that shown in FIGS. 1 and 1A.

### DETAILED DESCRIPTION OF THE INVENTION

An improved battery is described, having a tin-based negative electrode and a molten-salt electrolyte. A lithium ion battery having a tin-based negative electrode provides higher safety, improved capacity, and higher cell voltage than a conventional molten-salt Li-ion battery. The tin-based negative electrode also provides improved reversibility and durability.

Tin has a theoretical voltage of 0.4 V and a capacity of 993 mAh/g. In one example, tin-containing particles are supported on a support material. An electronic interaction between the tin-containing particles and the support material can then prevent, or slow, the electrolyte from reacting with the lower potential tin-containing particles, or reducing the rate of any such reaction.

A conventional Li₄Ti₅O₁₂ negative electrode has a theoretical voltage of 1.1 V and a capacity of 150 mAh/g. Hence, a tin-based negative electrode may provide a higher cell voltage and an improved capacity compared with conventional cell configurations.

A Sn-based negative electrode material can be used in a Li-ion battery with molten salt electrolyte. The following can be used to help prevent the molten salt electrolyte from decomposition:

(1) Electronic interaction between the support material and Sn containing nanoparticles on the surface of the support material.

(2) Formation of a solid electrolyte interface (SEI) layer on Sn-containing particles by decomposition of a part of the molten salt or other chemical additives dissolved in such electrolyte.

(3) Polymer thin layer coating on Sn-containing particles, for example supported on inactive support materials

(4) Formation of Sn-based alloys or partially oxidized alloys with a high potential window, the potential slowing or preventing molten salt electrolyte decomposition.

The support material can be in the form of a sheet, roughened surface, other textured surface, ceramic, xeolite, sol-gel, sintered form, intercalation compound, or three-dimensional structure. The tin-containing particles can be disposed on the surface of the support material, or distributed through the support material, or distributed through a near-surface region.

The tin-containing material can be in the form of particles, such as nanoparticles having a strong electronic interaction with the support material, this interaction slowing or substantially preventing decomposition of the molten salt electroltye. The particles may be substantially pure tin, a tin alloy, tin-containing material, or comprise tin-containing coating of a core material. The core material may be a support material such as discussed herein. A supporting structure for the tin-containing particles may be entirely formed from a single support material, or may include other material, such as a combination of materials, including materials used to improve strength, reliability, or other battery property.

Tin-containing material, for example in the form of particles can be chemically fixed to the surface of the support material, so that the interaction between the support material and the tin-containing particles prevents aggregation of the tin-containing particles and decomposition of molten salt electrolyte on tin-containing particles when the battery is cycled.

The support material may include silver (Ag), cobalt (Co), nickel (Ni), copper (Cu), molybdenum (Mo), vanadium (V), palladium (Pd), tungsten (W), other metal, semiconductor, or semi-metal, or alloys or compounds thereof. The support material may contain oxygen (e.g. as an oxide, such as titanium oxide), nitrogen (e.g. as a nitrate or nitride), phosphorus (e.g. as a phosphide or phosphate), or carbon (for example as a carbide). For example, the catalytic support may be tungsten carbide (WC), carbon coated with titanium oxide (such as TiO₂), titanium carbide (TiC), tantalum carbide (TaC), other transition metal carbide, other carbide, or other carbon-containing material. Chemical formula representations are exemplary, as other forms, such as non-stoichiometric compounds, can be used.

Molten salt electrolytes which may be used in embodiments of the invention are described in U.S. Pat. No. 4,463,071 to Gifford, U.S. Pat. No. 5,552,241 to Mamantov et al., U.S. Pat. No. 5,589,291 to Carlin et al., U.S. Pat. No. 6,326,104 to Caja et al., U.S. Pat. No. 6,365,301 to Michot, and U.S. Pat. No. 6,544,691 to Guidotti.

The molten salt electrolyte in the invention may include an onium, such as an ammonium, a phosphonium, an oxonium, a sulfonium, an amidinium, an imidazolium, a pyrazolium, and a low basicity anion, such as PF₆⁻, BF₄⁻, CF₃SO₃⁻, (CF₃SO₂)N⁻, (FSO₂)₂N⁻. The molten salt electrolyte in the invention may also include Y⁺N⁻(—SO₂Rf²)(—XRf³), where Y⁺ is a cation selected from the group consisting of an imidazolium ion, an ammonium ion, a sulfonium ion, a pyridinium, a(n) (iso)thiazolyl ion, and a(n) (iso) oxazolium ion, which may be optionally substituted with C₁₋₁₀ alkyl or C₁₋₁₀ alkyl having ether linkage, provided that said cation has at least one substituent of —CH₂Rf¹ or —OCH₂Rf¹ (where Rf is C₁₋₁₀ polyfluoroalkyl); Rf² and Rf³ are independently C₁₋₁₀ perfluorophenyl or may together from C₁₋₁₀ perfluoroalkylene; and X is —SO₂— or —CO—.

In a lithium-based battery, the molten salt electrolyte may contain a lithium salt such as one or more of the following: LiPF₆, LiAsF₆, LiSbF₆, LiBF₄, LiClO₄, LiCF₃SO₃, Li(CF₃SO₂)₂N, Li(C₂F₅SO₂)₂N, LiC₄F₉SO₃, Li(CF₃SO₂)₃C, LiBPh₄, LiBOB, and Li(CF₃SO₂)(CF₃CO)N.

Examples of the present invention can also include other batteries, such as other alkali metal or other cation based batteries, in which case an appropriate salt is used.

Additives may be dissolved in the electrolyte, such as a molten salt electrolyte. The electrolyte may include one or more of the molten salts and Li-salts mentioned above. The electrolyte may also include other organic compounds such as alkyl halides, epoxides, ether, organosulfur compounds and aliphatic amines, carbonyl compounds, carboxylic acid and their relatives, nitrile, imines, and nitro compounds, aromatic and heteroaromatic compounds, and the like. The additives can induce formation of SEI layers on the surface of Sn-containing particles after a certain electrochemical treatment, which may be cycling of the cell or other applied voltage profile. The formed SEI layer can prevent decomposition of molten salt electrolyte.

The protection layer can be a thin polymer layer on the surface of the tin-containing material, which may be particles such as Sn particles, Sn-based alloy or partially oxidized Sn-alloy particles. The polymer can have good elasticity, tensile strength, adhesivity, ion-conductivity, and thermal stability, which properties allow Li-ion transfer through from electrolyte to the surface of such Sn-based particles, and prevent decomposition of the electrolyte on the surface of the Sn-based particle. The protection layer may include one or more polymer such as a solid polymer electrolyte (or polymer electrolyte membrane), polyalklyene oxide, e.g. polyethylene oxide), polycarbonates, PVDF, and polymer complexes with lithium compounds. In order to increase Li-ion conductivity, the thin film may adsorb lithium salts such as sulfates (such as Li₂S₂O₄, Li₂SO₃, Li₂S₂O₅), perchlorates (such as LiClO₄), carbonates (such as Li₂CO₃), halides (fluorides, bromides, and chlorides such as LiCl), and other salts.

Protection layers may also include alkoxides such as lithium methoxide (LiOCH₃), other compounds of the form R—O—Li, salts of organic acids (such as R—CO₂Li).

In order to increase the potential of the Sn-based negative electrode to prevent the molten salt electrolyte from decomposition while maintaining its high capacity, Sn-alloys or partially oxidized Sn-alloy may be prepared, where the alloy may include tin and one or more of the following atomic species: Mg, Ti, V, Cr, Mo, Fe, Co, Ni, Cu, Zn, Ga, As, Zr, Nb, Ru, Rh, Pd, Ag, In, Sb, Ta, W, Ir, Pt, Au, Pb, and Bi.

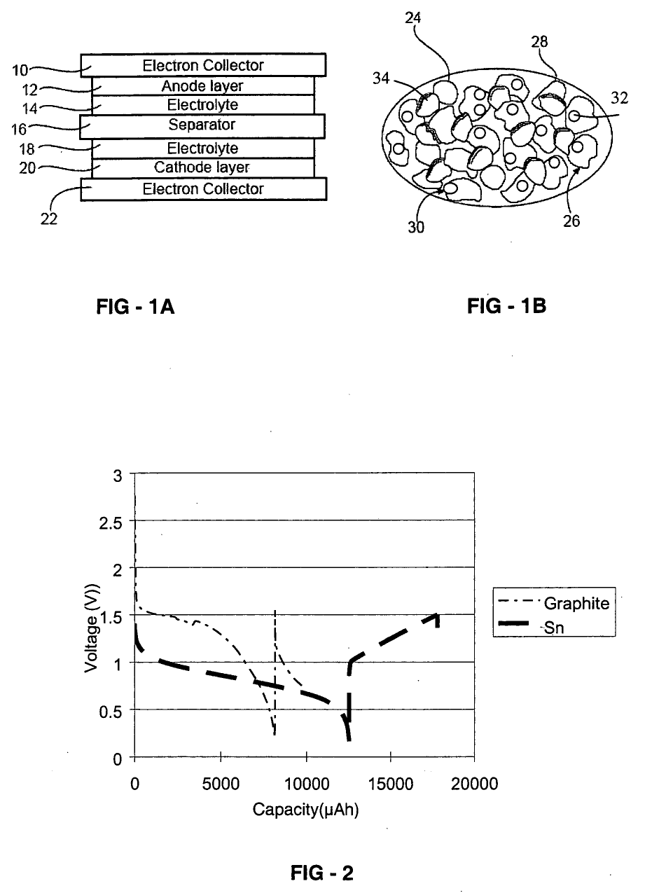

FIG. 1A shows an example Li-ion battery structure. The cell has electron collectors 10 and 22, positive electrode 20 (including positive electroactive material), electron conductive material, and binder material), electrolyte (at 14 and 18), separator (16), and negative electrode 12 (including a tin-containing negative electroactive material, electron conductive material, and binder).

FIG. 1B illustrates a possible negative electrode structure, comprising tin-containing particles (such as 32) supported by support material particles such as 24 and 28. An additional electron-conductive material (34) may be present, or optionally the support material and electron conductive material may be the same. The molten salt electrolyte may decompose on the surface of the tin-containing particles, for example at 30, due to the low potential of tin-based negative electrode materials. The surface of support material particles, and/or electron conductive materials, may also support a binder material, such as at surface 26. The inter-particle spaces may be filled with molten salt electrolyte.

This figure is not necessarily to scale. The tin-containing particles may be nanoparticles, and the supporting material particles may be microparticles.

Half cells (vs lithium metal) were prepared to prove the possibility of concept of Li-ion battery with molten salt electrolyte and Sn based negative electrode.

FIG. 2 shows that the charge/discharge performances are different between the Li-ion battery cells Sn-based negative electrode (0.4V) and carbon-graphite (0.1V). The results show that the Li-ion battery with Sn-based negative electrode and methyl-propyl-pyrrolidinium-bis-trifluoro-sulfonylamide (MPP-TFSI with Li-TFSI) molten salt can be cycled. However, the cell with a carbon graphite negative electrode and the same molten salt electrolyte could not be cycled. The results suggest the potential application of Sn-based negative electrode and molten salt electrolyte in a Li-ion battery with improved performance.

### EXAMPLE 1

The positive electrode was fabricated by intimately mixing 85 wt % Sn-based powder, 10 wt % carbon powder as electron conductive materials, and 5 wt % solvent of polyvinylidene fluoride in N-methylpyrrolidone. To form the positive electrode film, the mixed slurry was cast onto copper foil using a doctor blade and dried at 80° C. for 30 minutes.

Lithium metal foil was used as negative electrode.

The positive electrode sheet, a micro-porous polypropylene film separator, and the negative electrode sheet with an area of 2.83 cm² were stacked, and placed in aluminum laminate pack. A certain amount of molten salt electrolyte was added in to the laminate pack. Here, methyl-propyl-pyrrolidinium-bis-trifluoro-sulfonylamide (MPP-TFSI) with lithium-bis-trifluoromethan-sulfonylamide (LiTFSI) was used as the molten salt electrolyte.

### EXAMPLE 2

The positive electrode was fabricated by intimately mixing 92.5 wt % carbon graphite powder, and 7.5 wt % solvent of polyvinylidene fluoride in N-methylpyrrolidone. To form positive electrode film, the mixed slurry was cast onto copper foil by using doctor blade and dried at 80° C. for 30 minutes.

Lithium metal foil was used as negative electrode.

The positive electrode sheet, a micro-porous polypropylene film separator, and the negative electrode sheet with an area of 2.83 cm² were stacked, and placed in an aluminum laminate pack. A certain amount of molten salt electrolyte was added in to the laminate pack. Here, methyl-propyl-pyrrolidinium-bis-trifluoro-sulfonylamide (MPP-TFSI) with lithium-bis-trifluoromethan-sulfonylamide (LiTFSI) was used as the molten salt electrolyte.

Other Tin-Containing Materials

The tin-containing material can comprise particles, such as microparticles (for example, diameter range 1-500 microns), nanoparticles (diameter range 0.5 nm-1 micron), other size particles, or may have a range of sizes. The tin-containing material may comprise an alloy of tin and one or more metal from a group consisting of fourth row metals such as Ti, a fifth row metals such as Zr, sixth row metals such as Ta, and alkaline earth metals such as Mg. A tin-containing material may also comprise one or more other elements such as As or Bi. The percentage of tin (by weight or atomic ratio calculation) in the tin-containing material may approximately 50% or greater, for example 75% or greater, and the tin-containing material may be substantially metallic tin, having 90% or greater tin content.

The tin-containing material may be metallic tin, a tin alloy (including tin-containing intermetallic compounds) having a high tin content, such as more than 50% tin, a tin compound (such as a tin oxide, SnO or SnO₂, lithium tin oxide Li₂SnO₃, or other tin-containing oxide), or other tin-containing material.

Example tin-containing materials include alloys (including intermetallic compounds) including tin and another metal. Intermetallic compounds Mg₂Sn, CoSn₂, and NiSn₂ may be used. Alloys may be binary alloys, ternary alloys, or contain more than three metal types.

Particles used may have a uniform composition, or a tin-containing coating on a core material. The core material may comprise a non-tin containing material, and the core material may be a support material as described herein.

Tin-containing particles and a support material may interact, for example through an electronic interaction, to reduce reaction between the tin-containing particles and the electrolyte. The electronic interaction can reduce decomposition of the molten salt electrolyte, for example by modifying the potential of the tin-containing particles.

The tin-containing particles can be chemically fixed on the surface of support material, as the interaction will prevent aggregation of tin-containing particles and decomposition of molten salt electrolyte on the tin-containing particles when the battery cycled.

An improved negative electrode includes tin-containing particles, for example nanoparticles, distributed over the surface of a support material, or formed as a composite material with a support material. Further, decomposition of the electrolyte can be reduced by the electronic interaction between the support material and the tin-containing material, and the protection layer if one is used. Problems with disintegration of tin-based negative electroactive materials can be reduced by either providing the tin-based negative electroactive material as a nanostructured powder or nanoparticles, or alloying tin with one or more other metals. A quantum size effect can modify the electronic properties of the tin-containing particles, for example for nanoparticles having diameters approximately in the range 0.5-200 nm, such as 1-50 nm.

The protection layer thickness may be in the approximate range 0.5 nm-200 nm, such as between 5 nm and 50 nm.

Formation of Tin-Containing Particles

Tin-containing particles can be formed on the support material using chemical or physical vapor deposition methods, sputtering, evaporation, laser ablation, or other deposition method.

Tin-containing particles can also be formed by ball milling or other process, the particles then being deposited on the support material by any appropriate method.

Support Material Composition

The support material can be a material, such as an electron-conducting material, for example a material selected from the group consisting of: oxides having at least one element which belongs to group 2 to 14 in the third or subsequent period of the periodic table as a constituent element thereof; carbides having at least one element which belongs to group 2 to 14 in the third or subsequent period of the periodic table as a constituent element thereof; nitrides having at least one element which belongs to group 2 to 14 in the third or subsequent period of the periodic table as a constituent element thereof; and tungsten. Examples include SnO₂, Ti₄O₇, In₂O₃/SnO₂ (ITO), Ta₂O₅, WO₂, W₁₈O₄₉, CrO₂ and Tl₂O₃, in which the oxidation number of the metal in the oxide is relatively high, and hence the resistance to oxidation is good, and examples also include MgO, BaTiO₃, TiO₂, ZrO₂, Al₂O₃, and SiO₂, which have excellent electrochemical stability. Other examples include oxides, carbides, nitrides of Ti, Zr, Hf, V, Nb, Ta, Cr, Mo and W, and combinations of materials discussed herein (such as oxynitrides, oxycarbides, mixed metal compounds (oxides, nitrides, and carbides), and the like.

The support material may be formed as a surface layer on a substrate material. For example, the support material may be an outer layer of a particle, the substrate material being a core of the particle. Alternatively, the substrate material may be a sheet on which the support material is deposited (and may be an electron collector such as Cu, Al, Ni or Ti, or coating thereon). The substrate material may be an electron conducting material, for example carbon black, graphite, metals having a high electrical conductivity such as platinum (Pt), tungsten (W), aluminum (Al), copper (Cu) and silver (Ag), metal oxides such as Tl₂O₃, WO₂ and Ti₄O₇, tin oxide, and metal carbides such as WC, TiC and TaC.

Negative Electrode Configuration

A negative electrode for a lithium-ion battery comprises a negative electroactive material, (which may also be termed a negative electrode active material, or similar) such as the tin-containing materials described herein. The negative electroactive material includes a tin-containing material, which can be tin particles, tin-containing particles, and other forms of tin-containing materials such as sheets, fibers, and the like. The negative electroactive material may intercalate, alloy, or otherwise interact with lithium ions. The negative electrode may further include an electron-conducting material, or a binder.

The electron-conducting material may provide the support material for the tin-containing particles. The electron-conducting material may have a coating of a separate support material onto which the tin-containing material is disposed.

The support material can be in the form of a sheet, two-dimensional mesh, or a three-dimensional structure. The support material can be in the form of a sheet, roughened surface, other textured surface, ceramic, xeolite, sol-gel, sintered form, intercalation compound, or three-dimensional structure. The tin-containing particles can be disposed on the surface of the support material, or distributed through the support material, or distributed through a near-surface region proximate to the support material.

Other Support Material Composition

The support material may include a metal, semiconductor, semi-metal, alloy, compound, or other combination thereof. Examples include silver (Ag), cobalt (Co), nickel (Ni), copper (Cu), molybdenum (Mo), vanadium (V), palladium (Pd), tungsten (W). The support material may contain oxygen (e.g. as an oxide, such as titanium oxide), nitrogen (e.g. as a nitrate or nitride), phosphorus (e.g. as a phosphide or phosphate), or carbon (for example as a carbide, or graphite). For example, the support material may comprise one or more material selected from a group comprising: metal carbides, metal oxides, metal nitrides, pure metals, and alloys. Examples include tungsten carbide (WC), titanium dioxide (TiO₂, Ti₄O₇), titanium carbide (TiC), tantalum carbide (TaC), other metal carbide (such as a transition metal carbide), other carbide, or other carbon-containing material, metal nitrides like iron nitride (FeN), tungsten, platinum, and other metals or alloys.

Chemical formulas always intended to be exemplary, and other compositions, including non-stoichiometric compositions, may be used named compounds. The support material may itself be formed on a layer of another material. The support material may be a solid electron-conductive material, such as an electron-conducting oxide, carbide, or metal. The support material may comprise a semi-metal.

Positive Electrode

The positive electrode of a battery can be formed from any suitable material. A positive electrode for a lithium-ion battery may comprise lithium cobalt oxide (LiCoO₂), lithium manganese oxide (LiₓMn₂O₄), lithium nickel oxide (LiₓNiO₂), other lithium transition metal oxides, lithium metal phosphates, fluorinated lithium metal phosphates, and other lithium metal chalcogenides (such as lithium metal oxides), where the metal can be a transition metal. The lithium content varies with battery charge state.

Other Electrode Components

An electrode may further include non-electroactive materials such as an electron-conducting material. A non-electroactive material does not substantially interact with the electrolyte under normal operating conditions.

The electron-conducting material may comprise a carbon-containing material, such as graphite. Other example electron-conductive materials include polyaniline or other conducting polymer, carbon fibers, carbon black (such as acetylene black, or Ketjen black), and non-electroactive metals such as cobalt, copper, nickel, other metal, or metal compound. The electron conducting material may be in the form of particles (as used here, the term includes granules, flakes, powders and the like), fibers, a mesh, sheet, or other two or three-dimensional framework. The electron-conducting material may be the same as the support material.

An electrode may further include a binder, such as a polyethylene. The binder may be a fluoropolymer such as polytetrafluoroethylene. The binder may comprise one or more inert materials, for the purpose of improving the mechanical properties of the electrode, facilitating electrode manufacture or processing, or other purpose. Example binder materials include fluoropolymers (such as polytetrafluoroethylenes, polyvinylidene fluorides, and the like), polyolefins and derivatives thereof, polyethylene oxide, acrylic polymers (including polymethacrylates), synthetic rubber, and the like.

The electrode may further comprise regions of electrolyte, and/or an ion conductive protection layer to separate the negative electrode from the electrolyte, or other component or components. Electrodes may further comprise other non-electrically conducting, non-electroactive materials such as inert oxides, polymers, and the like.

Battery Configurations

An example battery includes a positive electrode, a negative electrode, an electrolyte, the electrolyte including lithium ions. An example battery may further include first and second current collectors, associated with negative electrode and positive electrode respectively. Examples of the present invention include other non-aqueous electrolyte secondary (rechargeable) batteries.

An example battery may further include electrical leads and appropriate packaging, for example a sealed container providing electrical contacts in electrical communication with the first and second current collectors.

Batteries may further include one or more separators, located between the negative electrode and positive electrode with the purpose of preventing direct contact between the negative electrode and the positive electrode. The separator is optional, and a solid electrolyte may provide a similar function. A separator may be a porous material, including a material such as a polymer (such as polyethylene or polypropylene), sol-gel material, ormosil, glass, ceramic, glass-ceramic, or other material, and may be in the form of a porous sheet, mesh, fibrous mat (cloth), or other form. A separator may be attached to a surface of one or both electrodes.

Other Applications

Other applications of the negative electrodes described herein include other rechargeable batteries using a different active cation include other alkali ion batteries, other batteries, other electrochemical devices, and the like.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Patents, patent applications, or publications mentioned in this specification are incorporated herein by reference to the same extent as if each individual document was specifically and individually indicated to be incorporated by reference. In particular, U.S. Prov. Pat. App. Ser. No. 60/553,394 filed Mar. 16, 2004, is incorporated herein in its entirety.

Having disclosed the invention, we claim:

1. A battery comprising:
a positive electrode;
a negative electrode, the negative electrode including a tin-containing material supported by a support material; and
a molten salt electrolyte located between the positive electrode and the negative electrode.

2. The battery of claim 1, wherein the battery is a lithium-ion battery.

3. The battery of claim 1, wherein the tin-containing material is a tin alloy.

4. The battery of claim 1, wherein the tin-containing material is separated from the molten salt electrolyte by a protection layer.

5. The battery of claim 1, wherein the protection layer is a polymer layer.

6. The battery of claim 1, wherein the protection layer is a solid electrolyte interface (SEI) layer.

7. The battery of claim 1, wherein the protection layer is formed by the decomposition of the molten salt electrolyte, the protection layer protecting the molten salt electrolyte from further decomposition.

8. The battery of claim 1, wherein the negative electrode comprises particles of the tin-containing material, the particles being supported by the support material.

9. The battery of claim 8, wherein the particles are nanoparticles.

10. The battery of claim 1, wherein the support material is a metal alloy.

11. The battery of claim 1, wherein the tin-containing material is an alloy of tin and one or more elements from the group of elements comprising Mg, Ti, V, Cr, Mo, Fe, Co, Ni, Cu, Zn, Ga, As, Zr, Nb, Ru, Rh, Pd, Ag, In, Sb, Ta, W, Ir, Pt, Au, Pb, and Bi.

12. The battery of claim 1, wherein the support material comprises one or more metals selected from a group of metals consisting of silver, cobalt, nickel, copper, molybdenum, vanadium, palladium, and tungsten.

13. The battery of claim 1, wherein the support material is an oxide, nitride, or carbide.

14. The battery of claim 1, wherein the tin-containing particles are nanoparticles, and the support material is an electrical conductor.

15. The battery of claim 1, wherein the tin-containing material includes over 50% tin.

16. The battery of claim 1, wherein the support material is an electron conductive material, and the negative electrode further includes a binder.

17. A battery comprising:
a positive electrode;
a negative electrode, the negative electrode including tin-containing particles; and
an electrolyte located between the positive electrode and the negative electrode, the tin-containing particles being separated from the electrolyte by a protection layer, the protection layer acting to slow the decomposition of the electrolyte by the tin-containing particles.

18. The battery of claim 17, wherein the protection layer is a polymer.
